(19) United States
(12) Patent Application Publication
(10) Pub. No.: US 2001/0032671 A1
(43) Pub. Date: Oct. 25, 2001

(54) Emergency air presure transfer tool

(76) Inventor: Dehart Hubbard, JR., Chattanooga, TN (US)

Correspondence Address: Dehart Hubbard, Jr., 2129 E. 28th Street, Chattanooga, TN, 37407, US

(21) Appl. No.: 09/839,968

(22) Filed: Apr. 20, 2001

Related U.S. Application Data
(60) Provisional application No. 60/199,185, filed on Apr. 24, 2000.

(51) Int. Cl. B60C 23/02

(52) U.S. Cl. 137/231

(57) ABSTRACT

A Bicycle Pump Fitting attached to a Clear Vinyl Hose. On the other end is a Completion Gauge with a Ball Foot Air Chuck with a clip. The Ball Foot Air Chuck holds the air pressure until the tool is installed. The clip holds the Ball Foot Air Chuck firmly on the tire stem during the air transfer process. The Completion Gauge will indicate that the air pressure transfer process is complete when the needle appears inside the Clear Vinyl Hose.

This tool, however, has its problems and is found to be a truly unsatisfactory solution to the transferring of air pressure One problem that occurred when using this tool was when attaching this tool to the tire which is filly inflated, air pressure would escape unless a shut-off valve was installed in the rubber hose between each bicycle pump fitting. Another problem that occurred when using this tool is when the tool was connected to each tire, there was no way to know when the transfer was complete.

### SUMMARY OF THE INVENTION

The present invention makes it possible to transfer air pressure easier and faster than any tool that has been developed within the last 100 years. A bicycle pump fitting is connected on one end of a clear vinyl hose and a hose barb fitting is connected to the other end. Inserted inside the hose barb fitting is a straight pin that has a round flat top. On top of the straight pin is a spring so that when air passes around the flat top of the straight pin, it depresses the pin upward so it can't be seen inside the vinyl hose. This is done to indicate that the air pressure transfer is in process

When the process is over, the spring presses the straight pin downward so it can be seen in the vinyl hose. This is done to indicate that the process is complete. The hose barb fitting with the straight pin and spring, screws into a ball foot air chuck, which has a clip. The ball foot air chuck allows the air pressure to be held back until the tool is installed. The ball foot air chuck has a clip, which holds the air chuck on the tire stem until the air pressure transfer process is complete.

### BRIEF DESCRIPTION OF THE DRAWINGS

FIG. 1 shows in perspective the Air Pressure Transfer Tool in its complete form.

FIG. 2 shows in perspective the Air Pressure Transfer Tool properly installed on a vehicle.

FIG. 3 shows in perspective the Bicycle Pump Fitting, the Slipover Hose Clamp and the Vinyl Hose (this end connects to the tire which is fully inflated).

FIG. 4 shows in perspective the completely assembled Air Pressure Transfer Tool with gauge in three stages of operation: 1) before operation, 2) during operation, and 3) completion of operation.

FIG. 5 shows in perspective the Air Pressure Transfer Tool Gauge disassembled into each separate part.

### DETAILED DESCRIPTION OF THE DRAWINGS

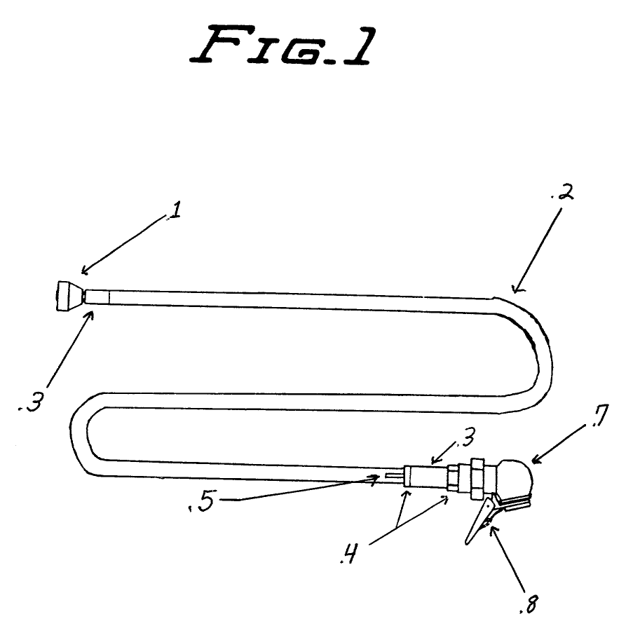

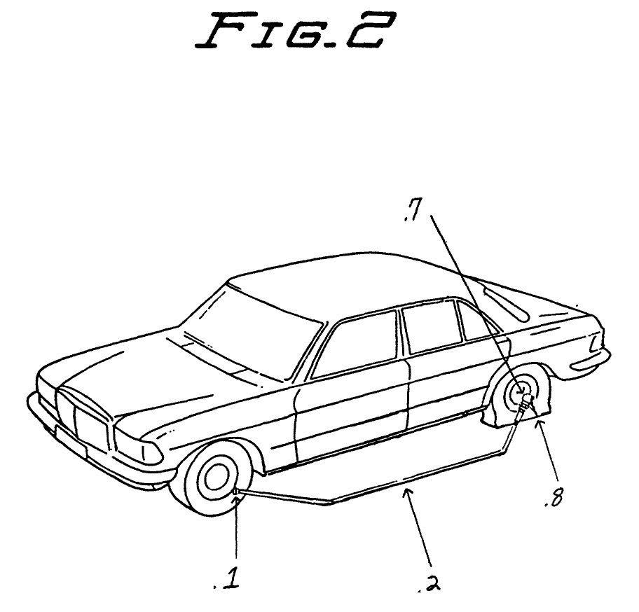

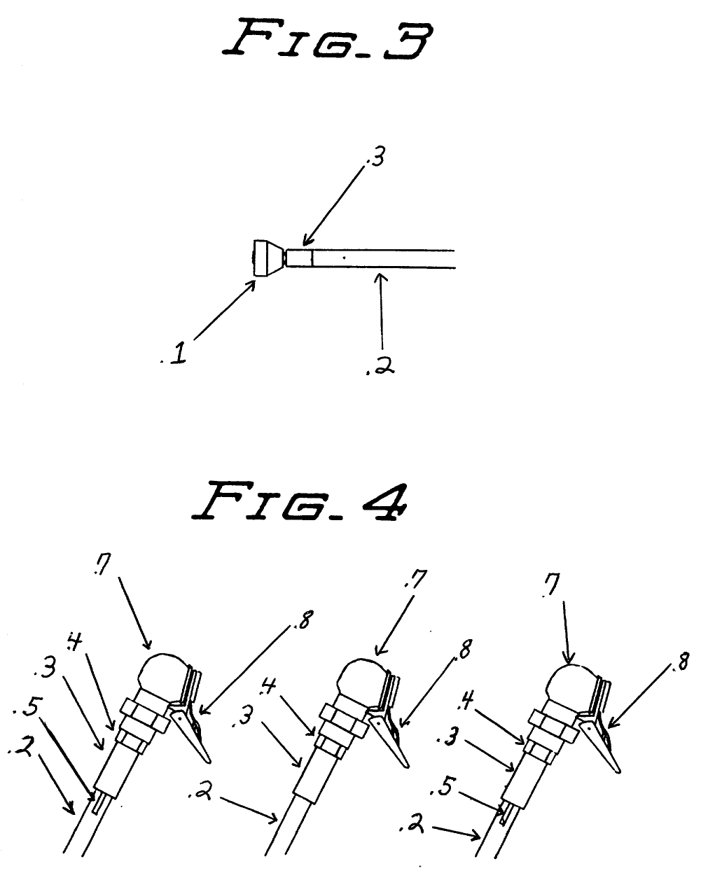

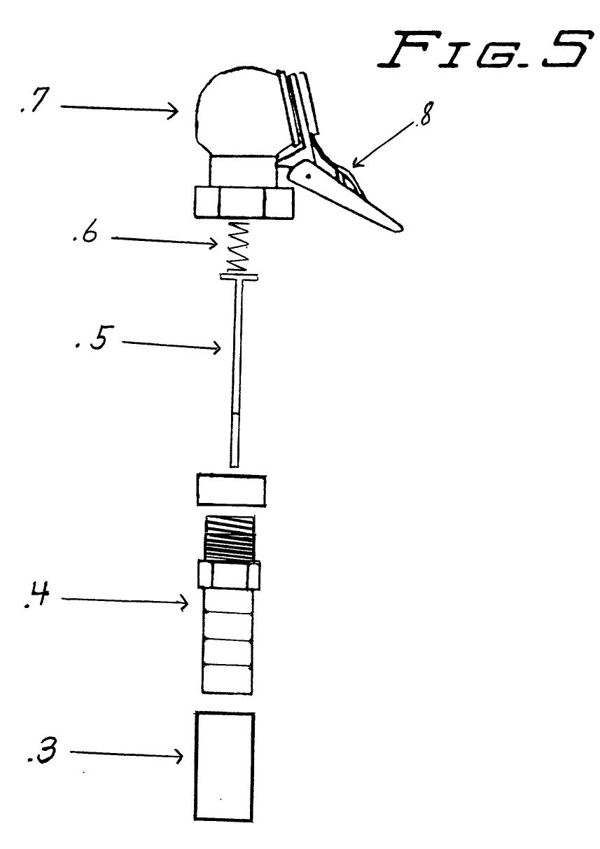

The Air Pressure Transfer Tool is shown in its complete form in FIG. 1. Also, FIG. 2 shows the Air Pressure Transfer Tool properly installed on a vehicle. The Bicycle Pump Fitting¹ is a major component to the Air Pressure Transfer Tool. This is shown in FIG. 1, FIG. 2, and FIG. 3. Connected to the Bicycle Pump Fitting¹ is a Clear Vinyl Hose². This is shown in FIG. 1, FIG. 2, FIG. 3 and FIG. 4. To hold the Clear Vinyl Hose² on the Bicycle Pump Fitting¹ is a Slipover Hose Clamp³. This is shown in FIG. 1, FIG. 3, FIG. 4 and FIG. 5.

On the other end of the Clear Vinyl Hose² is a Barb Hose Fitting⁴. This is shown in FIG. 1, FIG. 4, and FIG. 5. To hold the Clear Vinyl Hose² on the Barb Hose Fitting⁴ is another Slipover Hose Clamp³. Inside the Barb Hose Fitting⁴ is the Flat Top Straight Pin⁵. This is shown in FIG. 5. When air passes around the Flat Top Straight Pin⁵, it depresses the pin upward so it can't be seen. This is shown in FIG. 4.

On top of the Flat Top Straight Pin⁵ is a Pressure Spring⁶, shown in FIG. 5. When the air pressure transfer process is complete, the Pressure Spring⁶ presses the Flat Top Straight Pin⁵ downward so it can be seen in the Clear Vinyl Hose². This is also shown in FIG. 4. The Ball Foot Air Chuck⁷ screws onto the Barb Hose Fitting⁴ with the Flat Top Straight Pin⁵ and the Pressure Spring⁶ enclosed inside. This Ball Foot Air Chuck⁷ shown in FIG. 1, FIG. 2, FIG. 4 and FIG. 5, allows the air pressure to be held back until the tool is properly installed.

Attached to the Ball Foot Air Chuck⁷ is a Tire Stem Clip⁸, which is shown in FIG. 1, FIG. 2, FIG. 4 and FIG. 5. This Tire Stem Clip⁸ holds the Ball Foot Air Chuck⁷ properly on the tire stem during operation. Also, by squeezing the clip, it allows the Ball Foot Air Chuck⁷ to release the tire stem and stop the air pressure transfer process.

Having thus described my invention, I claim a flexible tube apparatus used to transfer air pressure from one tire to another, being portable, lightweight, automated in its operation, and comprised of:

1. A pin apparatus, which allows the user to monitor the flow of air pressure from one tire to another. Initially displayed to the user in its full length before the transfer begins, the aforementioned pin steadily detracts upward into the hose barb apparatus as the transfer of air progresses. When perfect balance of air pressure has been achieved between the two connected tires, the transfer of the air pressure automatically ceases and the pin detracts completely out for the user's view, signaling the end of the transfer process.

2. A clamp apparatus, which allows the present invention to easily attach to and detach from the tire.

3. A ball chuck apparatus, which prevents the seepage of air from the first connected tire, until the second tire can be connected.

4. An apparatus which has a plastic slipover hose clamp which connects the hose to each fitting on each end for a permanent connection.

5. An apparatus which is transparent, which allows a pin apparatus to be viewed during the air transfer operation.
